(19) United States
(12) Patent Application Publication
(10) Pub. No.: US 2018/0175412 A1
(43) Pub. Date: Jun. 21, 2018

(54) HUMIDIFIER INTEGRATED STACK

(71) Applicants: HYUNDAI MOTOR COMPANY, Seoul (KR); KIA MOTORS CORPORATION, Seoul (KR)

(72) Inventors: Duck Whan KIM, Seongnam-si (KR); Hyun Yoo KIM, Seoul (KR); Jung Han YU, Yongin-si (KR)

(21) Appl. No.: 15/723,975

(22) Filed: Oct. 3, 2017

(30) Foreign Application Priority Data
Dec. 16, 2016 (KR) 10-2016-0173030

(51) Int. Cl. H01M 8/04119; H01M 8/2457; H01M 8/2483

(52) U.S. Cl. CPC H01M 8/04126; H01M 8/2483; H01M 8/2457

(57) ABSTRACT

A humidifier integrated stack includes: unit cells including a fuel electrode and an air electrode; a stack module in which the unit cells are stacked; a manifold block having a predetermined space, an air inlet receiving air to be supplied to the air electrode from the outside, and an air outlet communicating with the predetermined space and discharging the air discharged from the air electrode to the outside; and a humidifying member communicating with the inlet in the space of the manifold block, and guiding the air supplied through the inlet to the air electrode through an internal hollow thereof, wherein the manifold block provides the space that allows the air discharged from the air electrode to supply moisture to the humidifying member while passing through the predetermined space and being discharged to the outlet, so as to humidify the air flowing through the hollow of the humidifying member.

### CROSS-REFERENCE TO RELATED APPLICATION

This application is based on and claims the benefit of priority to Korean Patent Application No. 10-2016-0173030, filed on Dec. 16, 2016, in the Korean Intellectual Property Office, the disclosure of which is incorporated herein in its entirety by reference.

### TECHNICAL FIELD

The present disclosure relates to a humidifier integrated stack.

### BACKGROUND

One of the factors that most directly affect the performance of a fuel cell during operation is to maintain a moisture content in a membrane electrode assembly (MEA), which is a core component of the fuel cell, by supplying an amount of moisture greater than or equal to a predetermined amount to an electrolyte membrane and ionomers in catalyst layers, thereby obtaining maximum ionic conductivity of the electrolyte membrane and the ionomers themselves.

Here, in order to supply moisture to the electrolyte membrane, a humidifier may be provided outside a fuel cell stack. If the humidifier is disposed outside the fuel cell stack, the total weight and volume of a fuel cell system may be increased.

### SUMMARY

The present disclosure has been made to solve the above-mentioned problems occurring in the prior art while advantages achieved by the prior art are maintained intact.

An aspect of the present disclosure provides a humidifier integrated stack that is configured to supply moisture of air discharged from an air electrode to a humidifying member through a predetermined space of a manifold block disposed at one end of a stack module to perform humidification, without having a separate humidifier outside the stack, thereby reducing the total weight and volume of a system.

According to an aspect of the present disclosure, a humidifier integrated stack may include: a plurality of unit cells each including a fuel electrode and an air electrode; a stack module in which the plurality of unit cells are stacked; a manifold block disposed at one end of the stack module in a direction in which the plurality of unit cells are stacked, having a predetermined space formed therein, and provided with an air inlet that receives air to be supplied to the air electrode from the outside and an air outlet that communicates with the predetermined space and discharges the air discharged from the air electrode to the outside; and a humidifying member provided to communicate with the air inlet in the predetermined space of the manifold block, and guiding the air supplied through the air inlet to the air electrode through an internal hollow thereof, wherein the manifold block provides the predetermined space that allows the air discharged from the air electrode to supply moisture to the humidifying member while passing through the predetermined space and being discharged to the air outlet, so as to humidify the air flowing through the hollow of the humidifying member.

The humidifying member may include a hollow fiber bundle including hollow fibers, each of which has the internal hollow formed in a lengthwise direction and fine holes formed in a surface thereof and communicating with the hollow to allow the moisture of the air discharged from the air electrode to be supplied to the hollow.

A first end of the hollow fiber bundle may be connected to the air inlet, and a second end of the hollow fiber bundle may be disposed adjacent to the air electrode in the direction in which the plurality of unit cells are stacked, and be connected to a supply hole for communicating a supply channel for guiding the air to the air electrode with the predetermined space.

The first end of the hollow fiber bundle may be sealed and fixed to the air inlet so that the air supplied through the air inlet does not leak into the predetermined space, and the second end of the hollow fiber bundle may be sealed and fixed to the supply hole so that the air in the hollow does not leak into the predetermined space.

The hollow fiber bundle may be provided in the predetermined space such that the first end thereof is connected to the air inlet, and the second end thereof is disposed adjacent to the air electrode in the direction in which the plurality of unit cells are stacked and is connected to a supply hole for communicating a supply channel for guiding the air to the air electrode with the predetermined space.

The first end of the hollow fiber bundle may be sealed so that the air supplied through the air inlet does not leak into the predetermined space, and the second end of the hollow fiber bundle may be sealed so that the air in the hollow does not leak into the predetermined space.

The first end and the second end of the hollow fiber bundle may be sealed using a PU potting agent.

The stack module may include: a first stack module including a plurality of unit cells each including a fuel electrode and an air electrode; and a second stack module disposed adjacent to the first stack module and including a plurality of unit cells each including a fuel electrode and an air electrode, and the hollow fiber bundle may include: a first bundle guiding the air supplied through the air inlet to the air electrode of the plurality of unit cells of the first stack module; and a second bundle guiding the air supplied through the air inlet to the air electrode of the plurality of unit cells of the second stack module.

The first and second bundles may have the same number and length of hollow fibers.

The humidifier integrated fuel cell stack may further include a support member fixed inside the predetermined space and supporting the hollow fiber bundle.

The support member may include a support tube having an insertion space formed therein, and the hollow fiber bundle may be inserted into the insertion space.

The support tube may include vent holes formed in a surface thereof and communicating with the insertion space to guide the air in the predetermined space to the insertion space.

The support member may include a support wall protruding from at least one of internal surfaces defining the predetermined space and supporting the hollow fiber bundle.

The air outlet may be positioned to allow the air discharged from the air electrode to flow across the humidifying member in the predetermined space and be discharged to the outside of the manifold block.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a humidifier integrated fuel cell stack according to a first exemplary embodiment of the present disclosure;

FIG. 2 illustrates a hollow fiber of FIG. 1,

FIG. 3 illustrates a hollow fiber bundle of FIG. 1;

FIG. 4 illustrates a humidifier integrated fuel cell stack according to a second exemplary embodiment of the present disclosure;

FIG. 5 illustrates a support member supporting a hollow fiber bundle according to an exemplary embodiment of the present disclosure; and

FIG. 6 illustrates the supply of moisture to a hollow fiber by the passage of air into a support tube according to an exemplary embodiment of the present disclosure.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

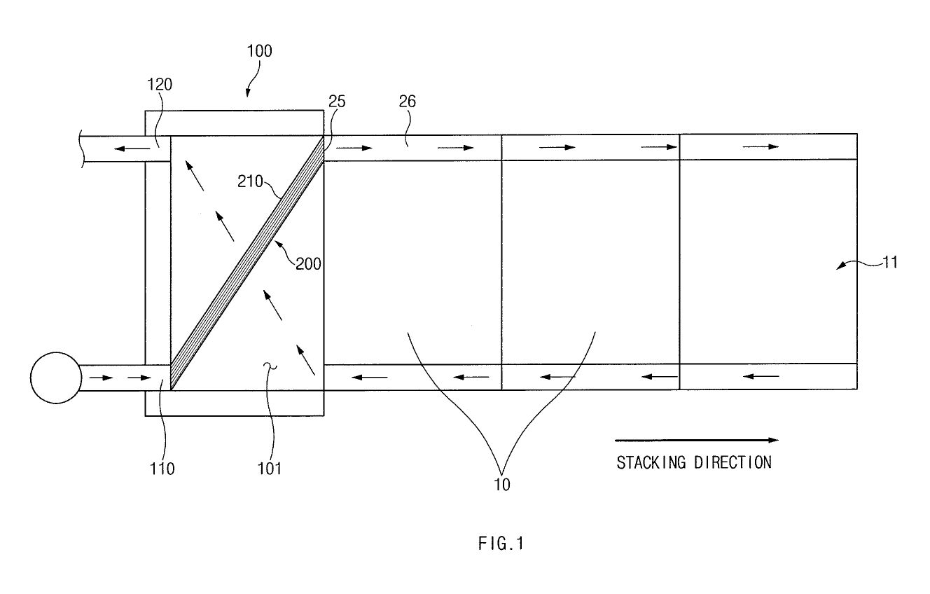

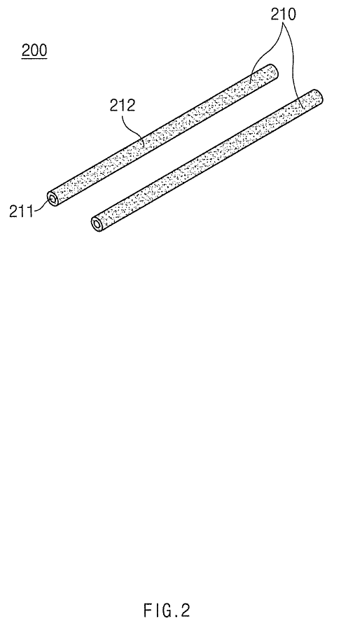

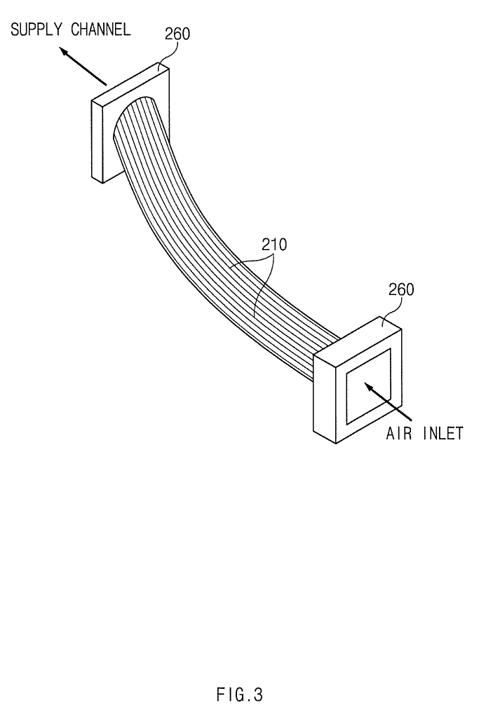

FIG. 1 illustrates a humidifier integrated fuel cell stack according to a first exemplary embodiment of the present disclosure. FIG. 2 illustrates a hollow fiber of FIG. 1, and FIG. 3 illustrates a hollow fiber bundle of FIG. 1. Hereinafter, the humidifier integrated fuel cell stack according to the exemplary embodiment of the present disclosure will be described with reference to FIGS. 1 to 3.

The humidifier integrated fuel cell stack includes a plurality of unit cells 10 each including a fuel electrode (anode) and an air electrode (cathode), a stack module 11 in which the unit cells 10 are stacked, a manifold block 100, and a humidifying member 200.

The manifold block 100 may be disposed at one end of the stack module 11 in a direction in which the unit cells 10 are stacked. The manifold block 100 may have a predetermined space 101 formed in the inside thereof.

The manifold block 100 may be provided with an air inlet 110 that receives air to be supplied to the air electrode from the outside, and an air outlet 120 that communicates with the predetermined space 101 and discharges the air discharged from the air electrode to the outside.

For example, the air inlet 110 may be connected to a blower (not shown). Due to the operation of the blower, dry air from the outside of the manifold block 100 may be introduced to the air inlet 110 and be guided to the humidifying member 200 to be described later.

The air outlet 120 may be formed to communicate with the predetermined space 101, and may be positioned to allow the air discharged from the air electrode to flow across the humidifying member 200 inside the predetermined space 101 and be discharged to the outside of the manifold block 100.

The position of the air outlet 120 is not particularly limited. The air outlet 120 may be positioned to allow the air discharged from the air electrode to be in contact with the humidifying member 200 to exchange moisture and be then discharged to the outside of the manifold block 100.

For example, an end plate (not shown) may be interposed between the manifold block 100 and the unit cells 10. A supply hole 25 to be described later may be formed in the end plate.

The humidifying member 200 may be disposed inside the predetermined space 101 of the manifold block 100, and may communicate with the air inlet 110. The humidifying member 200 may guide the air supplied through the air inlet 110 to the air electrode through an internal hollow thereof.

The predetermined space 101 of the manifold block 100 may be provided to exchange moisture of the air discharged from the air electrode with the humidifying member 200. The manifold block 100 may provide the predetermined space that allows the air discharged from the air electrode to exchange moisture with the air flowing through the hollow of the humidifying member 200 while passing through the predetermined space 101 and being discharged to the air outlet 120, supply the moisture to the humidifying member 200, and humidify the air flowing through the humidifying member 200.

The air flowing through the hollow of the humidifying member 200 may be humidified by the air discharged from the air electrode in the predetermined space 101 of the manifold block 100, and thus high space utilization may be achieved.

Since a separate humidifier is not required, the total weight of the stack may be reduced, and thus the stack may be miniaturized.

As illustrated in FIGS. 1 and 2, the humidifying member 200 includes a hollow fiber bundle 210 including hollow fibers, each of which has a hollow 211 formed in the inside thereof in a lengthwise direction, and fine holes 212 formed in the surface thereof. The fine holes 212 may communicate with the hollow 211 to supply the moisture of the air discharged from the air electrode to the hollow 211.

As illustrated in FIG. 1, one end of the hollow fiber bundle 210 may be connected to the air inlet 110. The other end of the hollow fiber bundle 210 may be disposed adjacent to the air electrode in the direction in which the unit cells 10 are stacked, and may be connected to the supply hole 25 allowing a supply channel 26 for guiding the air to the air electrode and the predetermined space 101 to communicate with each other.

Without being limited to the supply hole 25, any structure for guiding the air to the air electrode may be satisfied.

As illustrated in FIGS. 1 and 2, one end of the hollow fiber bundle 210 may be sealed and fixed to the air inlet 110 so that the air supplied through the air inlet 110 does not leak into the predetermined space 101, and the other end of the hollow fiber bundle 210 may be sealed and fixed to the supply hole 25 so that the air in the hollow 211 does not leak into the space predetermined 101.

One end and the other end of the hollow fiber bundle 210 may be sealed using a PU potting agent 260.

For example, the PU potting agent 260 may have high heat resistance and adhesion, and prevent the hollow fiber bundle 210 from being separated from the supply hole 25 and the air inlet 110.

The hollow fiber bundle 210 may be thin and bent. However, by fixing one end and the other end of the hollow fiber bundle 210 using the PU potting agent 260, the hollow fiber bundle 210 may be disposed in the predetermined space 101 without being in disarray.

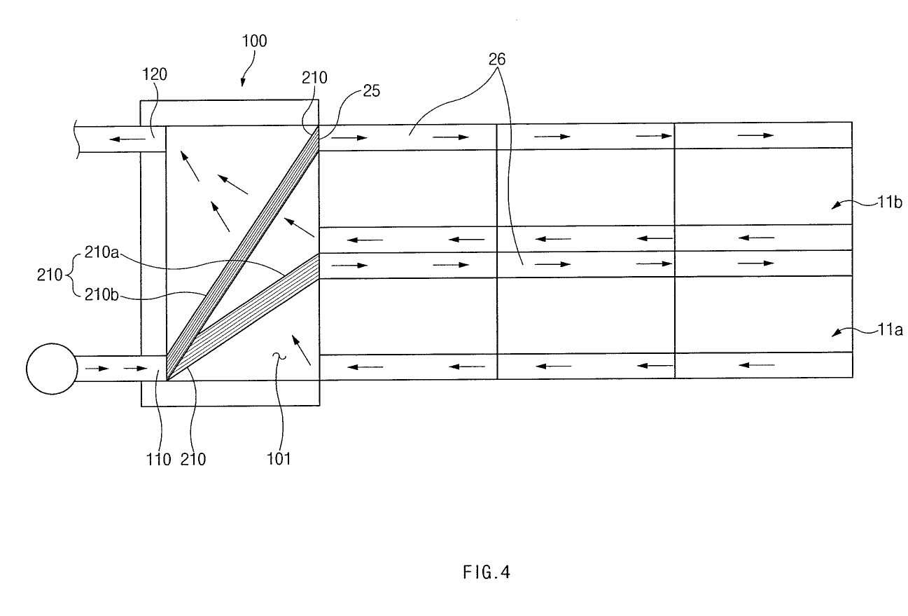

FIG. 4 illustrates a humidifier integrated fuel cell stack according to a second exemplary embodiment of the present disclosure.

The humidifier integrated fuel cell stack according to the second exemplary embodiment of FIG. 4 differs from that according to the first exemplary embodiment with respect to the structure of a humidifying member. Hereinafter, the same reference numerals will be used to designate the same elements, and redundant description will be omitted.

As illustrated in FIG. 4, the stack module 11 may include a first stack module 11a in which one set of the plurality of unit cells 10, each including a fuel electrode and an air electrode, are stacked, and a second stack module 11b in which another set of the plurality of unit cells 10, each including a fuel electrode and an air electrode, are stacked. The second stack module 11b may be disposed adjacent to the first stack module 11a.

The hollow fiber bundle 210 includes a first bundle 210a guiding the air supplied through the air inlet 110 to the air electrode of the plurality of unit cells of the first stack module 11a, and a second bundle 210b guiding the air supplied through the air inlet 110 to the air electrode of the plurality of unit cells of the second stack module 11b.

The first and second bundles 210a and 210b may have the same number and length of hollow fibers, be disposed in the predetermined space 101, and guide the air to the first and second stack modules 11a and 11b, respectively.

For example, by allowing the number and length of hollow fibers to be the same, the air may flow equally to the first and second stack modules 11a and 11b.

The first and second stack modules 11a and 11b may be disposed in two arrays, but are not limited thereto. The stack modules may be disposed in multiple arrays.

In order to configure the same number and length of hollow fibers to allow the air to flow equally to the plurality of stack modules 11, a portion of the hollow fiber bundle 210 may be bent. In this case, a support member may be added to support the hollow fiber bundle 210.

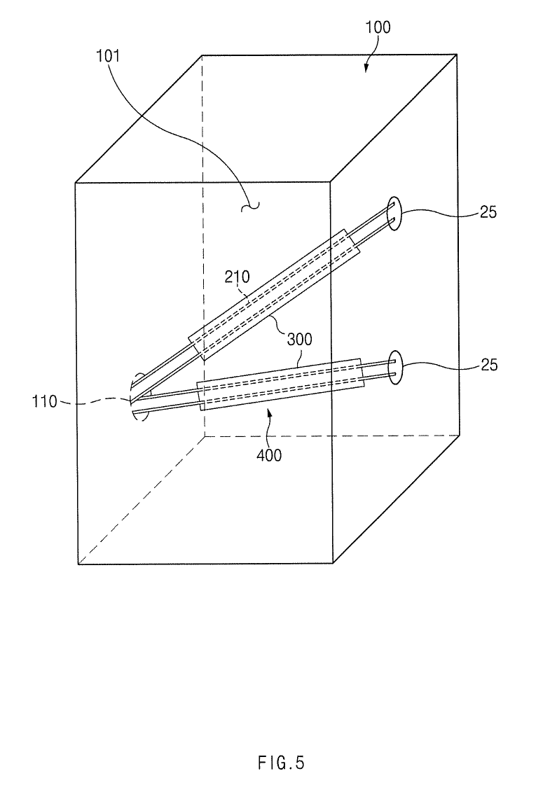

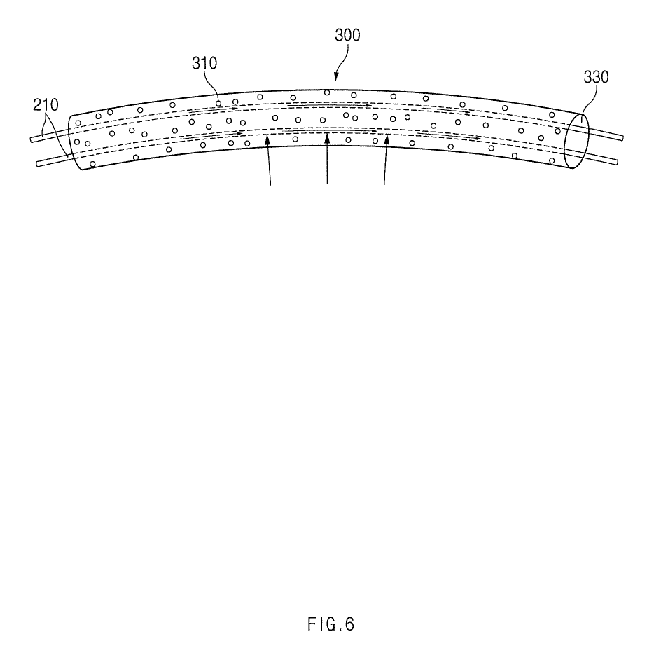

FIG. 5 illustrates a support member 400 supporting a hollow fiber bundle 210 according to an exemplary embodiment of the present disclosure, and FIG. 6 illustrates the supply of moisture to a hollow fiber by the passage of air into a support tube according to an exemplary embodiment of the present disclosure.

The humidifier integrated fuel cell stack according to an exemplary embodiment of the present disclosure may further include a support member 400.

As illustrated in FIG. 5, the support member 400 may be fixed to the inside of the predetermined space 101 to support the hollow fiber bundle 210.

The support member 400 includes a support tube 300. As illustrated in FIG. 6, the support tube 300 may have an insertion space 330 formed in the inside thereof, and vent holes 310 formed in the surface thereof. The hollow fiber bundle 210 may be inserted into the insertion space 330. The support tube 300 may have a tube shape.

The insertion space 330 and the vent holes 310 of the support tube 300 may communicate with each other.

The vent holes 310 may guide the air in the predetermined space 101 to the insertion space 330.

As illustrated in FIG. 6, by means of the vent holes 310, the air discharged from the air electrode may be in contact with the air flowing through the hollow 211 of the hollow fiber bundle 210 to exchange moisture. The air flowing through the hollow may be humidified in this manner.

For example, when the hollow fiber bundle 210 is connected from the air inlet 110 to the supply hole 25, the support tube 300 may prevent the thin hollow fiber bundle 210 from being bent and separated from the air inlet 110 and the supply hole 25, thereby maintaining the shape of the hollow fiber bundle 210.

For example, the support tube 300 may be connected to a support (not shown). The support may be disposed on at least one of internal surfaces defining the predetermined space 101 to support the support tube 300.

The support member 400 includes a support wall (not shown) protruding from at least one of the internal surfaces defining the predetermined space 101 and supporting the hollow fiber bundle 210.

The support wall may be provided to support the hollow fiber bundle 210 so as to prevent the hollow fiber bundle 210 from being bent from the air inlet 110 to the supply hole 25. A plurality of support walls may be provided, and the length thereof may be varied.

By supplying the moisture of the air discharged from the air electrode to the humidifying member 200 through the predetermined space 101 of the manifold block 100, the space utilization may be improved. The total weight of the stack may be reduced, and the stack may be miniaturized.

As set forth above, it is not necessary to provide a separate humidifier outside the stack, and thus the total weight of the stack can be reduced, thereby enabling miniaturization of a system.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A humidifier integrated fuel cell stack, comprising:
a plurality of unit cells each including a fuel electrode and an air electrode;
a stack module in which the plurality of unit cells are stacked;
a manifold block, disposed at one end of the stack module in a direction in which the plurality of unit cells are stacked, having a predetermined space formed therein, and provided with an air inlet that receives air to be supplied to the air electrode from an outside and an air outlet that communicates with the predetermined space and discharges the air discharged from the air electrode to the outside; and
a humidifying member provided to communicate with the air inlet in the predetermined space of the manifold block, and guiding the air supplied through the air inlet to the air electrode through an internal hollow thereof,
wherein the manifold block provides the predetermined space that allows the air discharged from the air electrode to supply moisture to the humidifying member while passing through the predetermined space and being discharged to the air outlet, so as to humidify the air flowing through the hollow of the humidifying member.

2. The humidifier integrated fuel cell stack according to claim 1, wherein the humidifying member comprises a hollow fiber bundle including hollow fibers, each of which has the internal hollow formed in a lengthwise direction and fine holes formed in a surface thereof and communicating with the hollow to allow the moisture of the air discharged from the air electrode to be supplied to the hollow.

3. The humidifier integrated fuel cell stack according to claim 2, wherein a first end of the hollow fiber bundle is connected to the air inlet, and
a second end of the hollow fiber bundle is disposed adjacent to the air electrode in the direction in which the plurality of unit cells are stacked, and is connected to a supply hole for communicating a supply channel for guiding the air to the air electrode with the predetermined space.

4. The humidifier integrated fuel cell stack according to claim 3, wherein the first end of the hollow fiber bundle is sealed and fixed to the air inlet so that the air supplied through the air inlet does not leak into the predetermined space, and
the second end of the hollow fiber bundle is sealed and fixed to the supply hole so that the air in the hollow does not leak into the predetermined space.

5. The humidifier integrated fuel cell stack according to claim 4, wherein the first end and the second end of the hollow fiber bundle are sealed using a PU potting agent.

6. The humidifier integrated fuel cell stack according to claim 3, wherein the stack module comprise:
a first stack module including a plurality of unit cells each including a fuel electrode and an air electrode; and
a second stack module disposed adjacent to the first stack module and including a plurality of unit cells each including a fuel electrode and an air electrode, and
wherein the hollow fiber bundle comprises:
a first bundle guiding the air supplied through the air inlet to the air electrode of the plurality of unit cells of the first stack module; and
a second bundle guiding the air supplied through the air inlet to the air electrode of the plurality of unit cells of the second stack module.

7. The humidifier integrated fuel cell stack according to claim 6, wherein the first and second bundles have a same number and length of hollow fibers.

8. The humidifier integrated fuel cell stack according to claim 3, further comprising a support member fixed inside the predetermined space and supporting the hollow fiber bundle.

9. The humidifier integrated fuel cell stack according to claim 8, wherein the support member comprises a support tube having an insertion space famed therein, and
the hollow fiber bundle is inserted into the insertion space.

10. The humidifier integrated fuel cell stack according to claim 9, wherein the support tube includes vent holes formed in a surface thereof and communicating with the insertion space to guide the air in the predetermined space to the insertion space.

11. The humidifier integrated fuel cell stack according to claim 8, wherein the support member comprises a support wall protruding from at least one of internal surfaces defining the predetermined space and supporting the hollow fiber bundle.

12. The humidifier integrated fuel cell stack according to claim 1, wherein the air outlet is positioned to allow the air discharged from the air electrode to flow across the humidifying member in the predetermined space and be discharged to the outside of the manifold block.
